(19) United States
(12) Patent Application Publication
(10) Pub. No.: US 2015/0214526 A1
(43) Pub. Date: Jul. 30, 2015

(54) ELECTROCHEMICAL CELLS COMPRISING REACTION PRODUCTS OF POLYIMIDES

(71) Applicants: BASF SE, Ludwigshafen (DE); BASF SCHWEIZ AG, Basel (CH)

(72) Inventors: Anna Cristadoro, Raleigh, NC (US); Oliver Gronwald, Frankfurt (DE); Benedikt Crone, Mannheim (DE); Raimund Pietruschka, Ebertsheim (DE); Ingrid Haupt, Frankenthal (DE)

(73) Assignee: BASF SE, lUDWIGSHAFEN (DE)

(21) Appl. No.: 14/425,119

(22) PCT Filed: Aug. 12, 2013
(86) PCT No.: PCT/EP2013/066793

§ 371 Date: Mar. 2, 2015

(30) Foreign Application Priority Data
Sep. 3, 2012 (EP) 12182764.6

(51) Int. Cl. H01M 2/16; H01M 4/131; H01M 4/485; H01M 10/0525; H01M 4/587; H01M 4/133; H01M 4/62

(52) U.S. Cl. CPC H01M 2/1653; H01M 4/133; H01M 4/131; H01M 4/625; H01M 2/162; H01M 10/0525; H01M 4/587; H01M 4/485; H01M 2220/20; H01M 2220/30

(57) ABSTRACT

Electrochemical cell comprising (A) at least one anode as component (A), (B) at least one cathode as component (B), (C) at least one non-aqueous electrolyte as component (C), (D) at least one separator positioned between anode (A) and cathode (B), as component (D), characterized in that separator (D) is manufactured from at least one polyimide selected from reaction products of (a) at least one polyimide selected from condensation products of (α) at least one polyisocyanate having on average at least two isocyanate groups per molecule and (β) at least one polycarboxylic acid having at least 3 COOH groups per molecule or an anhydride or ester thereof, and (b) at least one diol or triol, and subsequently optionally reacted with (c) at least one polyisocyanate having on average at least two isocyanate groups per molecule.

The present invention is directed towards a separator (D), comprising at least one reaction product of

(a) at least one polyimide selected from condensation products of
(α) at least one polyisocyanate having on average at least two isocyanate groups per molecule and
(β) at least one polycarboxylic acid having at least 3 COOH groups per molecule or an anhydride or ester thereof, and
   (b) at least one diol or triol,
   and subsequently optionally reacted with
   at least one polyisocyanate having on average at least two isocyanate groups per molecule.

Furthermore, the present invention is directed towards an electrochemical cell comprising
(A) at least one anode as component (A),
(B) at least one cathode as component (B),
(C) at least one none-aqueous electrolyte as component (C),
(D) at least one separator positioned between anode (A) and cathode (B), as component (D), characterized in that separator (D) is manufactured from at least one polyimide selected from reaction products of
   (a) at least one polyimide selected from condensation products of
      (α) at least one polyisocyanate having on average at least two isocyanate groups per molecule and
      (β) at least one polycarboxylic acid having at least 3 COOH groups per molecule or an anhydride or ester thereof, and
   (b) at least one diol or triol.

Said reaction product can subsequently be reacted with
(c) at least one polyisocyanate having on average at least two isocyanate groups per molecule.

Furthermore, the present invention is directed towards separators for electrochemical cells. Furthermore, the present invention is directed towards a method for manufacturing inventive separators.

Batteries and electrochemical cells with non-aqueous electrolytes are currently of great interest. Many components are of significance, such as the electrodes and the electrolyte. However, particular attention will be paid to the separator which physically separates the anode and the cathode, thereby preventing short circuits.

On one hand, the separator should allow Lithium ions to pass. On the other hand, a separator should have the necessary mechanical properties to effectively separate anode and cathode from each other.

Longevity is still an issue for lithium ion batteries. Sometimes, it has been observed that batteries produce short circuits after a number of cycles such as 40 or 50 cycles.

It was therefore an objective to provide electrochemical cells that do not suffer from short circuits after longer operation, such as after repeated cycling. It was further an objective to provide components for electrochemical cells that do not suffer from short circuits after longer operation. Furthermore, it was an objective to provide a method for manufacturing batteries that do not suffer from short circuits after longer operation.

Accordingly, the above electrochemical cells were found, hereinafter also referenced as inventive cells. Furthermore, the above separators (D) have been found, hereinafter also being referenced as inventive separators (D) or separators (D).

Separator (D) is manufactured from reaction products of

(a) at least one polyimide selected from condensation products of
(α) at least one polyisocyanate having on average at least two isocyanate groups per molecule and
(β) at least one polycarboxylic acid having at least 3 COOH groups per molecule or an anhydride or ester thereof, and
   (b) at least one diol or triol.

Said polyimide is briefly referred to as polyimide (a).

Polyimide (a) can have a molecular weight M_{w} in the range from 1,000 to 200,000 g/mol; preference is given to 2,000 to 20,000 g/mol.

Polyimide (a) can have at least two imide groups per molecule; preference is given to at least 3 imide groups per molecule.

In one embodiment of the present invention, polyimide (a) can have up to 1,000 imide groups per molecule, preferably up to 660 per molecule.

In one embodiment of the present invention, stating the isocyanate groups or the COOH groups per molecule in each case denotes the mean value (number-average).

Polyimide (a) can be composed of structurally and molecularly uniform molecules. However, preference is given to polyimide (a) being a mixture of molecularly and structurally differing molecules, for example, visible from the polydispersity M_{w}/Mₙ of at least 1.4, preferably M_{w}/Mₙ of 1.4 to 50, preferably 1.5 to 10. The polydispersity can be determined by known methods, in particular by gel permeation chromatography (GPC). A suitable standard is, for example, poly(methyl methacrylate) (PMMA).

In one embodiment of the present invention, polyimide (a), in addition to imide groups which form the polymer backbone, comprises, terminally or in side chains, in addition at least three, preferably at least six, more preferably at least ten, terminal or side-chain functional groups. Functional groups in polyimide (a) are preferably anhydride or acid groups and/or free or capped NCO groups. Polyimide (a) preferably does not have more than 500 terminal or side-chain functional groups, preferably no more than 100.

Alkyl groups such as, for example, methyl groups are therefore not a branching of a molecule of polyimide (a).

Polyisocyanate (α) can be selected from any polyisocyanates that have on average at least two isocyanate groups per molecule which can be present capped, or preferably free. Preferred polyisocyanates (α) are diisocyanates, for example hexamethylene diisocyanate, isophorone diisocyanate, toluylene diisocyanate, 4,4′-diphenylmethane diisocyanate, 2,4′-diphenylmethane diisocyanate, and mixtures of at least two of the abovementioned polyisocyanates (α). Preferred mixtures are mixtures of 4,4′-diphenylmethane diisocyanate and 2,4′-diphenylmethane diisocyanate and mixtures of 2,4-toluylene diisocyanate and 2,6-toluylene diisocyanate.

In another embodiment of the present invention, polyisocyanate (α) is selected from oligomeric hexamethylene diisocyanate, oligomeric tetramethylene diisocyanate, oligomeric isophorone diisocyanate, oligomeric diphenylmethane diisocyanate, trimeric toluylene diisocyanate and mixtures of at least two of the abovementioned polyisocyanates (α). For example, what is termed trimeric hexamethylene diisocyanate is in many cases not the pure trimeric diisocyanate, but the polyisocyanate having a mean functionality of 3.6 to 4 NCO groups per molecule. The same applies to oligomeric tetramethylene diisocyanate and oligomeric isophorone diisocyanate.

In one embodiment of the present invention, polyisocyanate (α) is a mixture of at least one diisocyanate and at least one triisocyanate or a polyisocyanate having at least 4 isocyanate groups per molecule.

In one embodiment of the present invention, polyisocyanate (α) has on average exactly 2.0 isocyanate groups per molecule. In another embodiment of the present invention, polyisocyanate (α) has on average at least 2.2, preferably at least 2.5, particularly preferably at least 3.0, isocyanate groups per molecule.

In one embodiment of the present invention, polyisocyanate (α) has on average up to 8, preferably up to 6, isocyanate groups per molecule.

In one embodiment of the present invention, polyisocyanate (α) is selected from oligomeric hexamethylene diisocyanate, oligomeric isophorone diisocyanate, oligomeric diphenylmethane diisocyanate and mixtures of the abovementioned polyisocyanates.

Polyisocyanate (α), in addition to urethane groups, can also have one or more other functional groups, for example urea, allophanate, biuret, carbodiimide, amide, ester, ether, uretonimine, uretdione, isocyanurate or oxazolidine groups.

As polycarboxylic acids (β), aliphatic or preferably aromatic polycarboxylic acids are selected that have at least three COOH groups per molecule, or the respective anhydrides, preferably when they are in the low-molecular weight form, that is to say the non-polymer form. Those polycarboxylic acids having 3 COOH groups in which two carboxylic acid groups are present as anhydride and the third as free carboxylic acid are also included.

In a preferred embodiment of the present invention, as polycarboxylic acid (β), a polycarboxylic acid having at least 4 COOH groups per molecule is selected, or the respective anhydride.

Examples of polycarboxylic acids (β) and anhydrides thereof are 1,2,3-benzenetricarboxylic acid and 1,2,3-benzenetricarboxylic monoanhydride, 1,3,5-benzenetricarboxylic acid (trimesic acid), preferably 1,2,4-benzenetricarboxylic acid (trimellitic acid), trimellitic anhydride and, in particular, 1,2,4,5-benzenetetracarboxylic acid (pyromellitic acid) and 1,2,4,5-benzenetetracarboxylic dianhydride (pyromellitic dianhydride), 3,3′,4,4′-benzophenonetetracarboxylic acid, 3,3′,4,4′-benzophenonetetracarboxylic dianhydride, in addition benzenehexacarboxylic acid (mellitic acid) and anhydrides of mellitic acid.

Other suitable polycarboxylic acids and anhydrides thereof are mellophanic acid and mellophanic anhydride, 1,2,3,4-benzenetetracarboxylic acid and 1,2,3,4-benzenetetracarboxylic dianhydride, 3,3,4,4-biphenyltetracarboxylic acid and 3,3,4,4-biphenyltetracarboxylic dianhydride, 2,2,3,3-biphenyltetracarboxylic acid and 2,2,3,3-biphenyltetracarboxylic dianhydride, 1,4,5,8-naphthalenetetracarboxylic acid and 1,4,5,8-naphthalenetetracarboxylic dianhydride, 1,2,4,5-naphthalenetetracarboxylic acid and 1,2,4,5-naphthalenetetracarboxylic dianhydride, 2,3,6,7-naphthalenetetracarboxylic acid and 2,3,6,7-naphthalenetetracarboxylic dianhydride, 1,4,5,8-decahydronaphthalenetetracarboxylic acid and 1,4,5,8-decahydronaphthalenetetracarboxylic dianhydride, 4,8-dimethyl-1,2,3,5,6,7-hexahydronaphthalene-1,2,5,6-tetracarboxylic acid and 4,8-dimethyl-1,2,3,5,6,7-hexahydronaphthalene-1,2,5,6-tetracarboxylic dianhydride, 2,6-dichloronaphthalene-1,4,5,8-tetracarboxylic acid and 2,6-dichloronaphthalene-1,4,5,8-tetracarboxylic dianhydride, 2,7-dichloronaphthalene-1,4,5,8-tetracarboxylic acid and 2,7-dichloronaphthalene-1,4,5,8-tetracarboxylic dianhydride, 2,3,6,7-tetrachloronaphthalene-1,4,5,8-tetracarboxylic acid and 2,3,6,7-tetrachloronaphthalene-1,4,5,8-tetracarboxylic dianhydride, 1,3,9,10-phenanthrenetetracarboxylic acid and 1,3,9,10-phenanthrenetetracarboxylic dianhydride, 3,4,9,10-perylenetetracarboxylic acid and 3,4,9,10-perylenetetracarboxylic dianhydride, bis(2,3-dicarboxyphenyl)methane and bis(2,3-dicarboxyphenyl)methane dianhydride, bis(3,4-dicarboxyphenyl)methane and bis(3,4-dicarboxyphenyl)methane dianhydride, 1,1-bis(2,3-dicarboxyphenyl)ethane and 1,1-bis(2,3-dicarboxyphenyl)ethane dianhydride, 1,1-bis(3,4-dicarboxyphenyl)ethane and 1,1-bis(3,4-dicarboxyphenyl)ethane dianhydride, 2,2-bis(2,3-dicarboxyphenyl)propane and 2,2-bis(2,3-dicarboxyphenyl)propane dianhydride, 2,3-bis(3,4-dicarboxyphenyl)propane and 2,3-bis(3,4-dicarboxyphenyl)propane dianhydride, bis(3,4-carboxyphenyl)sulfone and bis(3,4-carboxyphenyl)sulfone dianhydride, bis(3,4-carboxyphenyl) ether and bis(3,4-carboxyphenyl) ether dianhydride, ethylenetetracarboxylic acid and ethylenetetracarboxylic dianhydride, 1,2,3,4-butanetetracarboxylic acid and 1,2,3,4-butanetetracarboxylic dianhydride, 1,2,3,4-cyclopentanetetracarboxylic acid and 1,2,3,4-cyclopentanetetracarboxylic dianhydride, 2,3,4,5-pyrrolidinetetracarboxylic acid and 2,3,4,5-pyrrolidinetetracarboxylic dianhydride, 2,3,5,6-pyrazinetetracarboxylic acid and 2,3,5,6-pyrazinetetracarboxylic dianhydride, 2,3,4,5-thiophenetetracarboxylic acid and 2,3,4,5-thiophenetetracarboxylic dianhydride.

In one embodiment of the present invention, anhydrides from U.S. Pat. No. 2,155,687 or U.S. Pat. No. 3,277,117 are used for the synthesis of polyimide (a).

If polyisocyanate (α) and polycarboxylic acid (β) are condensed with one another—preferably in the presence of a catalyst—then an imide group is formed with elimination of CO₂ and H₂O. If, instead of polycarboxylic acid (β), the corresponding anhydride is used, then an imide group is formed with elimination of CO₂.

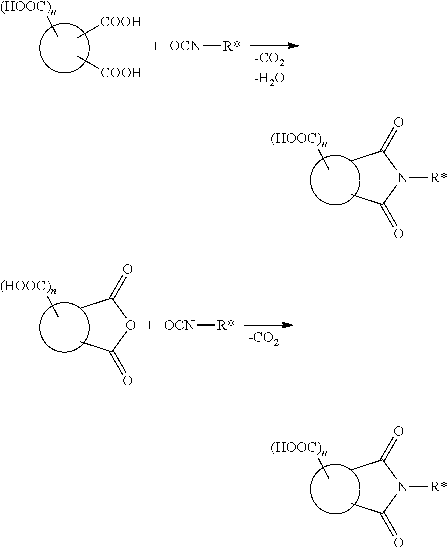

In this case R* is the radical of polyisocyanate (α) not specified further in the above reaction equation, and n is a number greater than or equal to 1, for example 1 in the case of a tricarboxylic acid or 2 in the case of a tetracarboxylic acid, wherein (HOOC)ₙ can be replaced by an anhydride group of the formula C(═O)—O—C(═O).

In one embodiment of the present invention, polyisocyanate (α) is used in a mixture with at least one diisocyanate, for example with toluylene diisocyanate, hexamethylene diisocyanate or with isophorone diisocyanate. In a particular variant, polyisocyanate (α) is used in a mixture with the corresponding diisocyanate, for example trimeric HDI with hexamethylene diisocyanate, or trimeric isophorone diisocyanate with isophorone diisocyanate, or polymeric diphenylmethane diisocyanate (polymer MDI) with diphenylmethane diisocyanate.

In one embodiment of the present invention, polycarboxylic acid (β) is used in a mixture with at least one dicarboxylic acid or with at least one dicarboxylic anhydride, for example with phthalic acid or phthalic anhydride.

Diol (b) or triol (b) can be low-molecular-weight or high-molecular-weight. Examples of triols (b) are glycerol and 1,1,1-(trihydroxymethylene)methane, 1,1,1-(trihydroxymethylene)ethane and 1,1,1-(trihydroxymethylene)propane.

Diols (b) are preferred.

As low-molecular-weight diols (b) in the context of the present invention, those having a molecular weight up to 500 g/mol which may be mentioned by way of example are: 1,2-ethanediol, 1,2-propanediol, 1,3-propanediol, 1,2-butanediol, 1,3-butanediol, 1,4-butanediol, 1,4-but-2-enediol, 1,4-but-2-ynediol, 1,5-pentanediol and positional isomers thereof, 1,6-hexanediol, 1,8-octanediol, 1,4-bishydroxymethylcyclohexane, 2,2-bis-(4-hydroxycyclohexyl)propane, 2-methyl-1,3-propanediol, diethylene glycol, triethylene glycol, tetraethylene glycol and, in particular, 2,2-dimethylpropane-1,3-diol (neopentyl glycol).

As polymeric diols, dihydric or polyhydric polyester polyols and polyether polyols may be mentioned, with the dihydric being preferred. As polyether polyols, preferably polyether diols come into consideration as are obtainable, for example, by boron trifluoride-catalyzed linking of ethylene oxide, propylene oxide, butylene oxide, tetrahydrofuran, styrene oxide or epichlorohydrin with itself or among one another or by addition of these compounds, individually or in a mixture, to starter components having reactive hydrogen atoms such as water, polyhydric alcohols, or amines such as 1,2-ethanediol, propane-(1,3)-diol, 1,2- or 2,2-bis-(4-hydroxyphenyl)propane or aniline. In addition, polyether-1,3-diols, for example trimethylol propane alkoxylated at an OH group, the alkylene oxide chain of which is closed with an alkyl radical comprising 1 to 18 carbon atoms, are preferably used polymeric diols.

Preferred polymeric diols (b) are: polyethylene glycol, polypropylene glycol and, in particular, polytetrahydrofuran (poly-THF).

Particularly preferably, polyether polyols are selected from: polyethylene glycol having an average molecular weight (Mₙ) in the range from 200 to 9000 g/mol, preferably in the range from 500 to 6000 g/mol, poly-1,2-propylene glycol or poly-1,3-propane diol having an average molecular weight (Mₙ) in the range from 250 to 6000, preferably 600 to 4000 g/mol, poly-THF having an average molecular weight (Mₙ) in the range from above 250 to 5000, preferably from 500 to 3000 g/mol, particularly preferably in the range from 750 to 2500 g/mol.

Other preferred polymeric diols are polyester polyols (polyester diols) and polycarbonate diols. As polycarbonate diols, in particular aliphatic polycarbonate diols may be mentioned, for example 1,4-butanediol polycarbonate and 1,6-hexanediol polycarbonate.

As polyester diols, those which may be mentioned are those which may be produced by polycondensation of at least one primary diol, preferably at least one primary aliphatic diol, for example ethylene glycol, 1,4-butanediol, 1,6-hexanediol, neopentyl glycol or, particularly preferably, 1,4-dihydroxymethylcyclohexane (as mixture of isomers) or mixtures of at least two of the abovementioned diols on the one hand and at least one, preferably at least two, dicarboxylic acids or anhydrides thereof on the other. Preferred dicarboxylic acids are aliphatic dicarboxylic acids such as adipic acid, glutaric acid, succinic acid and aromatic dicarboxylic acids such as, for example, phthalic acid and, in particular, isophthalic acid.

In one embodiment of the present invention, polyester diols and polycarbonate diols are selected from those having an average molecular weight (Mₙ) in the range from 500 to 9000 g/mol, preferably in the range from 500 to 6000 g/mol.

Very particularly preferred diols (b) are polytetrahydrofurans, for example having an average molecular weight Mₙ in the range from 250 to 2000 g/mol.

In one embodiment of the present invention, reaction product from polyimide (a) and diol (b) or triol (b) has an acid value in the range from zero to 300 mg of KOH/g, determined as specified in DIN 53402, preferably zero to 200 mg of KOH/g.

In one embodiment of the present invention, reaction product from polyimide (a) and diol (b) or triol (b) has a hydroxyl number in the range from zero to 300 mg of KOH/g, determined as specified in DIN 53240-2, preferably zero to 200 mg of KOH/g.

In one embodiment of the present invention, reaction product from polyimide (a) and diol (b) or triol (b) has a quotient M_{w}/Mₙ in the range from 1.2 to 10, preferably 1.5 to 5, particularly preferably 1.8 to 4. In this case, M_{w} and Mₙ are preferably determined by gel-permeation chromatography.

Some synthesis methods for making polyimides (a) are described below.

Preferred synthesis methods for making polyimides (a) comprise reacting with one another
(α) at least one polyisocyanate having on average at least two isocyanate groups per molecule and
(β) at least one polycarboxylic acid having at least 3 COOH groups per molecule or an anhydride or ester thereof,
   in the presence of a catalyst.

As catalysts, in particular water and Brøexisted bases are suitable, for example alkalimetal alcoholates, in particular alkanolates of sodium or potassium, for example sodium methanolate, sodium ethanolate, sodium phenolate, potassium methanolate, potassium ethanolate, potassium phenolate, lithium methanolate, lithium ethanolate and lithium phenolate.

For carrying out the synthesis method for making polyimides (a), polyisocyanate (α) and polycarboxylic acid (β) or anhydride (β) can be used in a quantitative ratio such that the molar fraction of NCO groups to COOH groups is in the range from 1:3 to 3:1, preferably 1:2 to 2:1. In this case, one anhydride group of the formula CO—O—CO counts as two COOH groups.

In an embodiment of the present invention, catalyst can be used in the range from 0.005 to 0.1% by weight, based on the sum of polyisocyanate (α) and polycarboxylic acid (β) or polyisocyanate (α) and anhydride (β). Preference is given to 0.01 to 0.05% by weight of catalyst.

In an embodiment of the present invention, a synthesis method for making polyimides (a) can be carried out at temperatures in the range from 50 to 200° C., preferably 50 to 140° C., particularly preferably 50 to 100° C.

In an embodiment of the present invention, a synthesis method for making polyimides (a) can be carried out at atmospheric pressure. However, the synthesis is also possible under pressure, for example at pressures in the range from 1.1 to 10 bar.

In an embodiment of the present invention, a synthesis method for making polyimides (a) can be carried out in the presence of a solvent or solvent mixture. Examples of suitable solvents are N-methylpyrrolidone, N-ethylpyrrolidone, dimethylformamide, dimethylacetamide, dimethyl sulfoxide, dimethyl sulphones, xylene, phenol, cresol, cyclic ethers such as, for example, tetrahydrofurane or 1,4-dioxane, cyclic acetals such as 1,3-dioxolane or 1,3-dioxane, ketones such as, for example, acetone, methyl ethyl ketone (MEK), methyl isobutyl ketone (MIBK), acetophenone, in addition mono- and dichlorobenzene, ethylene glycol monoethyl ether acetate and mixtures of two or more of the abovementioned mixtures. In this case, the solvent or solvents can be present during the entire synthesis time or only during part of the synthesis.

The reaction can be carried out, for example, for a time period of 10 minutes to 24 hours.

In a preferred embodiment of the present invention, the synthesis method for making polyimides (a) is carried out under inert gas, for example under argon or under nitrogen. If water-sensitive Brøexisted base is used as catalyst, it is preferred to dry inert gas and solvent. If water is used as catalyst, the drying of solvent and inert gas can be dispensed with.

In a special version of the synthesis method for making polyimides (a), NCO end groups of polyimide (a) can be blocked with a blocking agent (d), for example with secondary amine, for example with dimethylamine, di-n-butylamine or with diethylamine.

In one embodiment of the present invention, the reaction product of polyimide (a) with diol (b) or triol (b) can subsequently be reacted with

(c) one polyisocyanate having on average at least two isocyanate groups per molecule, briefly also referred to as polyisocanate (c).

Polyisocyanate (c) can be selected from any polyisocyanates that have on average at least two isocyanate groups per molecule which can be present capped, or preferably free. Preferred polyisocyanates (c) are diisocyanates, for example hexamethylene diisocyanate, isophorone diisocyanate, toluylene diisocyanate, 4,4′-diphenylmethane diisocyanate, 2,4′-diphenylmethane diisocyanate, and mixtures of at least two of the abovementioned polyisocyanates (α). Preferred mixtures are mixtures of 4,4′-diphenylmethane diisocyanate and 2,4′-diphenylmethane diisocyanate and mixtures of 2,4-toluylene diisocyanate and 2,6-toluylene diisocyanate.

In another embodiment of the present invention, polyisocyanate (c) is selected from oligomeric hexamethylene diisocyanate, oligomeric tetramethylene diisocyanate, oligomeric isophorone diisocyanate, oligomeric diphenylmethane diisocyanate, trimeric toluylene diisocyanate and mixtures of at least two of the abovementioned polyisocyanates (c). For example, what is termed trimeric hexamethylene diisocyanate is in many cases not the pure trimeric diisocyanate, but the polyisocyanate having a mean functionality of 3.6 to 4 NCO groups per molecule. The same applies to oligomeric tetramethylene diisocyanate and oligomeric isophorone diisocyanate.

In one embodiment of the present invention, polyisocyanate (c) is a mixture of at least one diisocyanate and at least one triisocyanate or a polyisocyanate having at least 4 isocyanate groups per molecule.

In one embodiment of the present invention, polyisocyanate (c) has on average exactly 2.0 isocyanate groups per molecule.

In one embodiment of the present invention, polyisocyanate (c) has on average up to 8, preferably up to 6, isocyanate groups per molecule. In another embodiment of the present invention, polyisocyanate (c) has on average at least 2.2, preferably at least 2.5, particularly preferably at least 3.0, isocyanate groups per molecule.

In one embodiment of the present invention, polyisocyanate (c) is selected from oligomeric hexamethylene diisocyanate, oligomeric isophorone diisocyanate, oligomeric diphenylmethane diisocyanate and mixtures of the abovementioned polyisocyanates.

Polyisocyanate (c), in addition to urethane groups, can also have one or more other functional groups, for example urea, allophanate, biuret, carbodiimide, amide, ester, ether, uretonimine, uretdione, isocyanurate or oxazolidine groups.

In one embodiment of the present invention, polyisocyanate (α) and polyisocyanate (c) of a specific separator (D) are equal. In an alternative embodiment, polyisocyanate (α) and polyisocyanate (c) of a specific separator (D) are different.

The reaction with polyisocyanate (c) can be carried out without or with a solvent, such as NMP, THF, 1,3-dioxolane or 1,4-dioxane.

The reaction with polyisocyanate (c) can be carried out without or with a catalyst, preferable it is carried out without.

The reaction with polyisocyanate (c) can be carried out at a temperature in the range of from 10 to 90° C., preferably 20 to 30° C.

In a preferred embodiment, the reaction with polyisocyanate (c) is carried out at normal pressure.

In one embodiment of the present invention, separator (D) has a thickness in the range of from 1 μm to 150 μm, preferably 15 μm to 110 μm.

In one embodiment of the present invention, the specific ionic conductivity at room temperature of separator (D) in liquid electrolyte is in the range of from 10⁻⁶ S/cm to 10⁻³ S/cm, determined by impedance measurements of sandwich cells with separator/electrolyte combinations.

Separator (D) is manufactured from at least one polyimide, said polyimide being characterized below. To be manufactured in the context of the separator means that the separator is manufactured using at least one polyimide (a).

In one embodiment of the present invention, separator further contains one or more inorganic particles (E). Inorganic particles can be selected, e. g., from oxides of Ti, Zr, Si or Al, non-stoichiometric or stoichiometric, preferred is SiO₂.

Inventive separators (D) are very well suitable for manufacturing inventive electrochemical cells. Another aspect of the present invention are thus electrochemical cells comprising at least one inventive separator (D).

Inventive electrochemical cells comprise
(A) at least one anode as component (A), briefly also referred to as anode (A),
(B) at least one cathode as component (B), briefly also referred to as cathode (B),
(C) at least one non-aqueous electrolyte as component (C), briefly also referred to as electrolyte (C),
(D) at least one separator positioned between anode (A) and cathode (B), as component (D) or separator (D).

Inventive cells can be selected from alkali metal containing cells. Preferably, inventive cells are selected from lithium-ion containing cells. In lithium-ion containing cells, the charge transport is effected by Li⁺ ions.

In the context with the present invention, the electrode where during discharging a net negative charge occurs is called the anode.

Anode (A) can be selected from anodes being based on various active materials. Suitable active materials are metallic lithium, carbon-containing materials such as graphite, graphene, charcoal, expanded graphite, furthermore lithium titanate (Li₄Ti₅O₁₂), tin oxide (SnO₂), and nanocrystalline silicon.

In a special embodiment of the present invention, anode (A) is selected from graphite anodes and lithium titanate anodes.

Anode (A) can further comprise a current collector. Suitable current collectors are, e.g., metal wires, metal grids, metal gaze and preferably metal foils such as copper foils.

Anode (A) can further comprise a binder. Suitable binders can be selected from organic (co)polymers. Suitable organic (co)polymers may be halogenated or halogen-free. Examples are polyethylene oxide (PEO), cellulose, carboxymethyl cellulose, polyvinyl alcohol, polyethylene, polypropylene, polytetrafluoroethylene, polyacrylonitrile-methyl methacrylate, styrenebutadiene copolymers, tetrafluoroethylene-hexafluoropropylene copolymers, vinylidene fluoridehexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polysulphones, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

The average molecular weight M_{w} of binder may be selected within wide limits, suitable examples being 20,000 g/mol to 1,000,000 g/mol.

In one embodiment of the present invention, anode (A) can have a thickness in the range of from 15 to 200 μm, preferably from 30 to 100 μm, determined without the current collector. Inventive cells further comprise a cathode (B). Cathode (B) can be, e. g., air (or oxygen). In a preferred embodiment, however, cathode (B) contains a solid active material.

Solid active materials for cathode (B) can be selected from phosphates with olivine structure such as lithium iron phosphates (LiFePO₄) and lithium manganese phosphate (LiMnPO₄) which can have a stoichiometric or non-stoichiometric composition and which can be doped or not doped.

In one embodiment of the present invention, active material for cathode (B) can be selected from lithium containing transition metal spinels and lithium transition metal oxides with a layered crystal structure. In such cases, cathode (B) contains at least one material selected from lithium containing transition metal spinels and lithium transition metal oxides with a layered crystal structure, respectively.

In one embodiment of the present invention, lithium-containing metal spinels are selected from those of the general formula

LiₐM¹_{b}Mn_{3-a-b}O_{4-d} (I)

the integers being defined as follows:
0.9≦a≦1.3, preferably 0.95≦a≦1.15,
0≦b≦0.6, for example 0.0 or 0.5,
wherein, if M¹=Ni, 0.4≦b≦0.55,
−0.1≦d≦0.4, preferably 0≦d≦0.1,

M¹ is selected from one or more out of Al, Mg, Ca, Na, B, Mo, W and transition metals of the first row of the transition metals in the periodic table of the elements. In a preferred embodiment, M¹ is selected from the group consisting of Ni, Co, Cr, Zn, and Al. Even more preferably, M¹ is defined to be Ni.

In one embodiment of the present invention, lithium containing metal spinels are selected from LiNi_{0.5}Mn_{1.5}O_{4-d} and LiMn₂O₄.

In one embodiment of the present invention, lithium transition metal oxides with a layered crystal structure are selected from compounds of general formula (II)

Li₁₊ₜM²₁₋ₜO₂ (II)

the integer being defined as follows:
0≦t≦0.3 und

M² selected from one or more elements from Al, Mg, B, Mo, W, Na, Ca and transition metals of the first row of the transition metals in the periodic table of the elements, at least one element being manganese.

In one embodiment of the present invention, at least 30 mole-% of M² are selected from manganese, preferably at least 35 mole-%, in each time with respect to the complete amount of M².

In one embodiment of the present invention M² is selected from combinations of Ni, Co and Mn not containing significant amounts of additional elements.

In a different embodiment of the present invention M² is selected from combinations of Ni, Co and Mn containing significant amounts of at least one additional element, for example in the range of from 1 to 10 mole-% Al, Ca or Na.

In a particular embodiment of the present invention, lithium transition metal oxides with a layered crystal structure are selected from compounds of general formula

Li₍₁₊ₓ₎[NiₑCo_{f}Mn_{g}M³ₕ]₍₁₋ₓ₎O₂ (III)

the integers being defined as follows:
x a number in the range of from zero to 0.2,
e a number in the range of from 0.2 to 0.6,
f a number in the range of from 0.1 to 0.5,
g a number in the range of from 0.2 to 0.6,
h a number in the range of from zero to 0.1,
and: e+f+g+h=1,
M³ selected from Al, Mg, V, Fe, Cr, Zn, Cu, Ti and Mo.

In one embodiment of the present invention, M² in formula (II) is selected from Ni_{0.33}Co_{0.33}Mn_{0.33}, Ni_{0.5}Co_{0.2}Mn_{0.3}, Ni_{0.4}CO_{0.3}Mn_{0.4}, Ni_{0.4}Co_{0.2}Mn_{0.4} and Ni_{0.45}Co_{0.10}Mn_{0.45}.

Cathode (B) can further comprise a current collector. Suitable current collectors are, e.g., metal wires, metal grids, metal gaze and preferably metal foils such as aluminum foils.

Cathode (B) can further comprise a binder. Suitable binders can be selected from organic (co)polymers. Suitable organic (co)polymers may be halogenated or halogen-free. In general, the same binders used for anode (A) can also be employed for cathode (B).

Preferred binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In one embodiment of the present invention, cathode (B) can have a thickness in the range of from 15 to 200 μm, preferably from 30 to 100 μm, determined without the current collector.

Cathode (B) can further comprise electrically conductive carbonaceous material.

Electrically conductive carbonaceous material can be selected, for example, from graphite, carbon black, carbon nanotubes, graphene or mixtures of at least two of the aforementioned substances. In the context of the present invention, electrically conductive, carbonaceous material can also be referred to as carbon for short.

In one embodiment of the present invention, electrically conductive carbonaceous material is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or ironcontaining impurities are possible in carbon black.

In one variant, electrically conductive carbonaceous material is partially oxidized carbon black.

Inventive electrochemical cells further comprise at least one electrolyte (C). Electrolyte (C) in the context of the present invention can encompass at least one salt, preferably a lithium salt, and at least one non-aqueous solvent.

In one embodiment of the present invention, nonaqueous solvent may be liquid or solid at room temperature, preferably selected from polymers, cyclic or noncyclic ethers, cyclic and non-cyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5,000,000 g/mol, preferably up to 2,000,000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (IV) and (V)

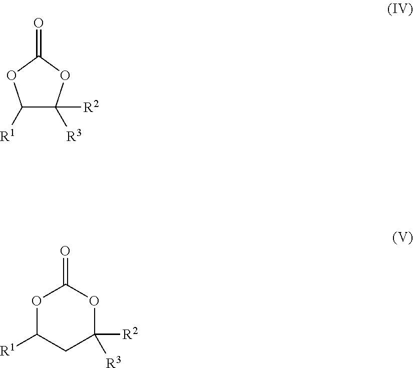

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (VI).

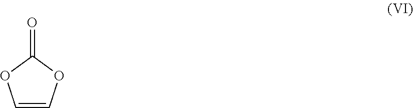

The solvent(s) is (are) preferably used in what is known as the anhydrous state, i.e. with a water content in the range from 1 ppm to 0.1% by weight, determinable, for example, by Karl Fischer titration.

Electrolyte further comprises one or more conductive salts. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, LiPF_{w}(CₙF₂ₙ₊₁)_{6-w}, lithium imides such as LiN(CₙF₂₊₁SO₂)₂, where n is an integer in the range from 1 to 20, LiN(SO₂F)₂, Li₂SiF₆, LiSbF₆, LiAlCl₄, and salts of the general formula (CₙF₂₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

The integer w is a number in the range of from 1 to 6, preferably w=3.

Preferred conductive salts are selected from LiC(CF₃SO₂)₃, LiN(CF₃SO₂)₂, LiPF₆, LiBF₄, LiClO₄, and LiPF₃(CF₂CF₃)₃, particular preference being given to LiPF₆, LiPF₃(CF₂CF₃)₃ and LiN(CF₃SO₂)₂.

In one embodiment of the present invention, the concentration of conductive salt in electrolyte is in the range of from 0.01 M to 5 M, preferably 0.5 M to 1.5 M.

Inventive electrochemical cells further comprise at least one separator (D), said separator being positioned between anode (A) and cathode (B).

In one embodiment of the present invention, separator (D) is positioned between anode (A) and cathode (B) in a way that it is like a layer to either a major part of one surface of anode (A) or cathode (B).

In one embodiment of the present invention, separator (D) is positioned between anode (A) and cathode (B) in a way that it is like a layer to both a major part of one surface of anode (A) and cathode (B).

In a preferred embodiment of the present invention, separator (D) is positioned between anode (A) and cathode (B) in a way that it is like a layer to one surface of anode (A) or of cathode (B).

In another preferred embodiment of the present invention, separator (D) is positioned between anode (A) and cathode (B) in a way that it is like a layer to one surface of both anode (A) and of cathode (B).

In one embodiment of the present invention, separator (D) has a thickness in the range of from 1 μm to 150 μm, preferably 15 μm to 110 μm.

In one embodiment of the present invention, the specific ionic conductivity at room temperature of separator (D) in liquid electrolyte is in the range of from 10⁻⁶ S/cm to 10⁻³ S/cm, determined by impedance measurements of sandwich cells with separator/electrolyte combinations.

Separator (D) is manufactured from at least one polyimide, said polyimide being characterized below. To be manufactured in the context of the separator means that the separator is manufactured using at least one polyimide (a).

In one embodiment of the present invention, separator further contains one or more inorganic particles (E). Inorganic particles can be selected, e. g., from oxides of Ti, Zr, Si or Al, non-stoichiometric or stoichiometric, preferred is SiO₂.

In one embodiment of the present invention, inventive electrochemical cells can contain additives such as wetting agents, corrosion inhibitors, or protective agents such as agents to protect any of the electrodes or agents to protect the salt(s).

In one embodiment of the present invention, inventive electrochemical cells can have a disc-like shape. In another embodiment, inventive electrochemical cells can have a prismatic shape.

In one embodiment of the present invention, inventive electrochemical cells can include a housing that can be from steel or aluminium.

In one embodiment of the present invention, inventive electrochemical cells are combined to stacks including electrodes that are laminated.

In one embodiment of the present invention, inventive electrochemical cells are selected from pouch cells.

Inventive electrochemical cells have overall advantageous properties. They have a long duration with very low loss of capacity, good cycling stability, and a reduced tendency towards short circuits after longer operation and/or repeated cycling.

A further aspect of the present invention refers to batteries containing at least one inventive electrochemical cell, for example two or more. Inventive batteries have advantageous properties. They have a long duration with very low loss of capacity, good cycling stability, and high temperature stability.

A further aspect of the present invention is the use of inventive electrochemical cells or inventive batteries according for making or operating cars, computers, personal digital assistants, mobile telephones, watches, camcorders, digital cameras, thermometers, calculators, laptop BIOS, communication equipment or remote car locks, and stationary applications such as energy storage devices for power plants. A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one inventive battery or at least one inventive electrochemical cell.

A further aspect of the present invention is the use of reaction products of
(a) at least one polyimide selected from condensation products of
   (α) at least one polyisocyanate having on average at least two isocyanate groups per molecule and
      (β) at least one polycarboxylic acid having at least 3 COOH groups per molecule or an anhydride or ester thereof, and
(b) at least one diol or triol
   as or for manufacturing of separators in electrochemical cells.

Said reaction product can optionally subsequently be reacted with
(c) at least one polyisocyanate having on average at least two isocyanate groups per molecule.

A further aspect of the present invention is a separator, comprising at least reaction product of

(a) at least one polyimide selected from condensation products of
(α) at least one polyisocyanate having on average at least two isocyanate groups per molecule and
(β) at least one polycarboxylic acid having at least 3 COOH groups per molecule or an anhydride or ester thereof, and
   (b) at least one diol or triol.

Said reaction product can optionally subsequently be reacted with

(c) at least one polyisocyanate having on average at least two isocyanate groups per molecule.

Polyimide (a) and diol (b) and triol (b) have been defined above.

In one embodiment of the present invention, inventive separator (D) has a thickness in the range of from 1 μm to 150 μm, preferably 10 μm to 35 μm.

In one embodiment of the present invention, the specific ionic conductivity at room temperature of inventive separator (D) in liquid electrolyte is in the range of from 10⁻⁶ S/cm to 10⁻³ S/cm, determined by impedance measurements of sandwich cells with separator/electrolyte combinations.

A further aspect of the present invention is a method for manufacturing inventive separators. Said inventive method comprises making a film of polyimide (a).

In one embodiment of the inventive method, one dissolves at least one polyimide (a) in a suitable solvent or mixture of solvents and then applies said solution to a flat surface, for example to a glass surface or to a metal foil, e. g., an aluminum foil, or to a plastics foil such as a polyethylene terephthalate film (PET foil). Then one removes the solvent or solvents, respectively. Afterwards, the inventive separator can be removed from the flat surface, for example mechanically.

Examples for suitable solvents are, e. g., cyclic or non-cyclic amides, ketones, acetals, and cyclic and non-cyclic ethers.

Examples for cyclic amides are N-methylpyrrolidone (NMP) and N-ethylpyrrolidone (NEP). Examples for non-cyclic amides are N,N-dimethylformamide and N,N-dimethylacetamide. Examples for ketones are acetone, methylethylketone, methyl isobutyl ketone (MIBK), and cyclohexanone. Examples for acetals are 1,2-dimethoxyethane and 1,3-dioxolane. Examples for ethers are di-n-butyl ether, tetrahydrofurane, 1,4-dioxolane and preferably anisole.

Solutions of at least one polyimide (a) can have a solids content in the range of from 5 to 50% by weight, preferably 15 to 30% by weight.

Application of the solution to a flat surface can be performed by spraying, blade coating, spin coating, drop casting, or dip coating.

Removal of the solvent(s) can be achieved by evaporating the solvent(s) or allowing to evaporate, for example by heating, or via reduction of pressure, or via using a gas stream.

Removal of the separator from the flat surface can be achieved by mere mechanical means, or it can be supported by softening, e.g., by allowing to rest in a solvent with poor solution ability, such as water.

In another embodiment, inventive separators can be made by applying a solution of

(a) at least one polyimide selected from condensation products of
(α) at least one polyisocyanate having on average at least two isocyanate groups per molecule and
(β) at least one polycarboxylic acid having at least 3 COOH groups per molecule or an anhydride or ester thereof, and
   (b) at least one diol or triol,

Said reaction product can optionally subsequently be reacted with

(c) at least one polyisocyanate having on average at least two isocyanate groups per molecule.
to a flat surface, and allow to in situ form a reaction product. Then the solvent(s) is/are removed.

In another embodiment, inventive separators can be made by applying a solution of

(a) at least one polyimide selected from condensation products of
(α) at least one polyisocyanate having on average at least two isocyanate groups per molecule and
(β) at least one polycarboxylic acid having at least 3 COOH groups per molecule or an anhydride or ester thereof,
   to a flat surface, and reacting polyimide (a) with
   (b) at least one diol or triol,
   and—optionally—subsequently with
   (c) at least one polyisocyanate having on average at least two isocyanate groups per molecule,
   in solution or in substance, and allow polyimide (a) and diol(s) (b) or triol(s) (b) to form a reaction product. Then the solvent(s) is/are removed.

Inventive separators (D) have overall advantageous properties. They help to secure a long duration of electrochemical cells with very low loss of capacity, good cycling stability, and a reduced tendency towards short circuits after longer operation and/or repeated cycling. They can help batteries to have a long duration with very low loss of capacity, good cycling stability, and high temperature stability.

The present invention will be illustrated by non-limiting working examples.

### WORKING EXAMPLES

### General Remarks

Polyisocyanate (α.1): polymeric 4,4′-diphenylmethane diisocyanate (“Polymer-MDI”), average of 2.7 isocyanate groups per molecule, dynamic viscosity: 195 mPa·s at 25° C., commercially available as Lupranat® M20W.

Polyisocyanate (α.2): isocyanurate from hexamethylendiisocyanate, average of 3,6 isocyanate groups per molecule.

Polyisocyanate (α.3): 4,4′-diphenylmethane diisocyanate, average of 2 isocyanate groups per molecule, dynamic viscosity: 5 mPa·s at 25° C., commercially available as Lupranat® MES.

Polycarboxylic acid (β.1): dianhydride of 1,2,4,5-benzene tetracarboxylic acid

Diol (b.1): poly-THF having an average molecular weight Mₙ of 1000 g/mol

Diol (b.2): poly-THF having an average molecular weight Mₙ of 250 g/mol

Diol (b.3): polypropylenglycol having an average molecular weight Mₙ of 1100 g/mol

Diol (b.4: polyethylenglycol having an average molecular weight Mₙ of 1000 g/mol

Diol (b.5): polyethylenglycol having an average molecular weight Mₙ of 1500 g/mol

“NCO”: NCO content, determined by IR spectroscopy unless expressly mentioned otherwise, it is indicated in % by weight.

The molecular weights were determined by gel permeation chromatography (GPC using a refractometer as detector). The standard used was polymethyl methacrylate (PMMA). The solvents used were N,N-dimethylacetamide (DMAc) or tetrahydrofurane (THF), if not stated otherwise.

Percentages are % by weight unless expressly mentioned otherwise.

The molecular weights were determined by gel-permeation chromatography (GPC). The standard used was polystyrene (PS). The solvent used was tetrahydrofuran (THF), where not explicitly stated otherwise. Detection was performed using an Agilent 1100 differential refractometer or an Agilent 1100 VWD UV photometer.

The NCO content was determined titrimetrically as specified in DIN EN ISO 11 909 and reported in % by weight.

The syntheses were carried out under nitrogen, if not described otherwise.

### I. Production of Polyimides

### 1.1 Synthesis of Reaction Product RP.1

An amount of 100 g (0.46 mol) of polycarboxylic acid (β.1) were dissolved in 1400 ml of acetone which was not dried before the reaction and therefore comprised water and placed in a 4-l four-neck flask having a dropping funnel, reflux cooler, internal thermometer and Teflon agitator. Then, 173 g (0.69 mol) of polyisocyanate (α.1) were added dropwise at 20° C. The mixture was heated with stirring to 55° C. The mixture was stirred for a further six hours under reflux at 55° C. Thereafter, 600 g of diol (b.1) (0.6 mol) were added. The temperature was increased to 60° C. and acetone was distilled off at atmospheric pressure in the course of 4 hours. Thereafter, the mixture was heated to 125° C. and the pressure decreased to 200 mbar. Thereafter, the resulting residue was stripped in the flask with nitrogen. This produced reaction product RP.1 as a solid yellow mass.

Mₙ=8,360 g/mol, M_{w}=21,000 g/mol

### M_{w}/Mₙ=2.5

OH number: 22 mg KOH/g
Acid value: 88 mg KOH/g

### I.2 Synthesis of Reaction Product RP.2

An amount of 100 g (0.46 mol) of polycarboxylic acid (β.1) were dissolved in 1400 ml of acetone which was not dried before the reaction and therefore comprised water and placed in a 4-l four-neck flask having a dropping funnel, reflux cooler, internal thermometer and Teflon agitator. Then 115 g (0.46 mol) of polyisocyanate (α.1) were added dropwise at 20° C. The mixture was heated with stirring to 55° C. The mixture was stirred for a further six hours under reflux at 55° C. Thereafter, 1000 g of diol (b.1) (1.0 mol) were added and the mixture was stirred under reflux at 55° C. for 14 hours. The temperature was increased to 60° C. and acetone was distilled off in the course of 4 hours at atmospheric pressure. Thereafter, the mixture was heated to 125° C. and the pressure was reduced to 200 mbar. Thereafter, the resulting residue was stripped in the flask with nitrogen. This produced reaction product RP.2 as a solid yellow mass.

Mₙ=7250 g/mol, M_{w}=16 900 g/mol

### M_{w}/Mₙ=2.3

OH number: 26 mg KOH/g
Acid value: 40 mg KOH/g

### I.3 Synthesis of Reaction Product RP.3

An amount of 100 g (0.46 mol) of polycarboxylic acid (β.1) were dissolved in 1400 ml of acetone which was not dried before the reaction and therefore comprised water and placed in a 4-l four-neck flask having a dropping funnel, reflux cooler, internal thermometer and Teflon agitator. Then, 115 g (0.69 mol) of polyisocyanate (α.1) were added dropwise at 20° C. The mixture was heated to 55° C. with stirring. The mixture was stirred for a further six hours under reflux at 55° C. Thereafter, 300 g of diol (b.1) (0.3 mol) were added. The mixture was stirred for a further six hours under reflux at 55° C. and thereafter the temperature was increased to 60° C. and acetone was distilled off in the course of 4 hours at atmospheric pressure. Thereafter, the mixture was heated to 125° C. and the pressure was reduced to 200 mbar. Thereafter, the residue was stripped in the flask with nitrogen. This produced reaction product RP.3 as a solid yellow mass.

Mₙ=3670 g/mol, M_{w}=11 900 g/mol

### M_{w}/Mₙ=3.2

OH number: 37 mg KOH/g
Acid value: 144 mg KOH/g

### I.4 Synthesis of Reaction Product RP.4

An amount of 100 g (0.46 mol) of polycarboxylic acid (β.1) were dissolved in 1400 ml of acetone which was not dried before the reaction and therefore comprised water and placed in a 4-l four-neck flask having a dropping funnel, reflux cooler, internal thermometer and Teflon agitator. Then, 173 g (0.69 mol) of polyisocyanate (α.1) were added dropwise at 20° C. The mixture was heated to 55° C. with stirring. The mixture was stirred for a further five hours under reflux at 55° C. Thereafter, 390 g of diol (b.1) (0.6 mol) were added. The temperature was increased to 60° C. and acetone was distilled off in the course of 7 hours at atmospheric pressure. Thereafter, the mixture was heated to 80° C. and the pressure was reduced to 200 mbar. Thereafter, the resulting residue was stripped in the flask with nitrogen. This produced reaction product RP.4 as a solid yellow mass.

Mₙ=5900 g/mol, M_{w}=14 000 g/mol

### M_{w}/Mₙ=2.4

OH number: 14 mg KOH/g
Acid value: 107 mg KOH/g

### I.5 Synthesis of Reaction Product RP.5

An amount of 100 g (0.46 mol) of polycarboxylic acid (β.1) were dissolved in 1400 ml of acetone which was not dried before the reaction and therefore comprised water and placed in a 4-l four-neck flask having a dropping funnel, reflux cooler, internal thermometer and Teflon agitator. Then, 173 g (0.69 mol) of polyisocyanate (α.1) were added dropwise at 20° C. The mixture was heated to 55° C. with stirring. The mixture was stirred for a further five hours under reflux at 55° C. Thereafter, 173 g of diol (b.2) (0.6 mol) were added. The temperature was increased to 60° C. and acetone was distilled off in the course of 7 hours at atmospheric pressure. Thereafter the mixture was heated to 80° C. and the pressure reduced to 200 mbar. Thereafter, the residue was stripped in the flask with nitrogen. This produced reaction product RP.5 according to the invention as a solid yellow mass.

Mₙ=4360 g/mol, M_{w}=8370 g/mol

### M_{w}/Mₙ=1.9

OH number: 12 mg KOH/g
Acid value: 151 mg KOH/g

### I.6 Synthesis of Reaction Product RP.6

An amount of 100 g (0.46 mol) of polycarboxylic acid (β.1) were dissolved in 1400 ml of acetone which was not dried before the reaction and therefore comprised water and placed in a 4-l four-neck flask having a dropping funnel, reflux cooler, internal thermometer and Teflon agitator. Then, 115 g (0.46 mol) of isocyanate (α.3) were added dropwise at 20° C. The mixture was heated to 55° C. with stirring. The mixture was stirred for a further five hours under reflux at 55° C. Thereafter, 300 g of diol (b.1) (0.3 mol) were added. The temperature was increased to 55° C. and stirred at this temperature for five hours. Then acetone was distilled off in the course of 6 hours at atmospheric pressure. Thereafter the mixture was heated to 80° C. and the pressure reduced to 200 mbar. This produced reaction product RP.6 according to the invention as a solid yellow mass, which was then dissolved in 530 ml 1,3-dioxolane.

Mₙ=3670 g/mol, M_{w}=11900 g/mol

M_{w}/Mₙ=3.2

OH number: 37 mg KOH/g

Acid value: 144 mg KOH/g

### I.7 Synthesis of Reaction Product RP.7

An amount of 50 g (0.23 mol) of polycarboxylic acid (β.1) were dissolved in 450 ml of 1,3 dioxolane with 0.45 g of water and placed in a 4-l four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further five hours at 55° C. Thereafter, 150 g of diol (b.1) (0.15 mol) were added. The temperature was increased to 55° C. and stirred at 55° C. temperature for five hours. This produced reaction product RP.7 according to the invention, which was then dissolved in 1,3-dioxolane.

Mₙ=3377 g/mol, M_{w}=9951 g/mol

### M_{w}/Mₙ=2,9

OH number: 15 mg KOH/g
Acid value: 77 mg KOH/g

### I.8 Synthesis of Reaction Product RP.8

An amount of 50 g (0.23 mol) of polycarboxylic acid (β.1) were dissolved in 700 ml of acetone which was not dried before the reaction and therefore comprised water and placed in a 4-l four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further seven hours under reflux at 55° C. Thereafter, 75 g of diol (b.1) (0.075 mol) and 82.5 g of diol (b.3) (0.075 mol) were added. The temperature was increased to 55° C. and stirred at this temperature for six hours. Then acetone was distilled off in the course of 3 hours at atmospheric pressure. Thereafter the mixture was heated to 60° C. and the pressure reduced to 200 mbar. This produced reaction product RP.8 according to the invention as a solid yellow mass, which was dissolved in 265 ml 1,3-dioxolane.

Mₙ=4064 g/mol, M_{w}=10,560 g/mol

### M_{w}/Mₙ=2.6

OH number: 18 mg KOH/g
Acid value: 76 mg KOH/g

### I.9 Synthesis of Reaction Product RP.9

An amount of 50 g (0.23 mol) of polycarboxylic acid (β.1) were dissolved in 700 ml of acetone which was not dried before the reaction and therefore comprised water and placed in a 4-l four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further seven hours under reflux at 55° C. Thereafter, 30 g of diol (b.1) (0.003 mol) and 132 g of diol (b.3) (0.12 mol) were added. The temperature was increased to 55° C. and stirred at this temperature for five hours. Then acetone was distilled off in the course of four hours at atmospheric pressure. Thereafter the mixture was heated to 60° C. and the pressure reduced to 200 mbar. This produced reaction product RP.9 according to the invention as a solid yellow mass, which was dissolved in 270 ml 1,3-dioxolane.

Mₙ=3562 g/mol, M_{w}=8536 g/mol

### M_{w}/Mₙ=2.4

OH number: 8 mg KOH/g
Acid value: 71 mg KOH/g

### I.10 Synthesis of Reaction Product RP.10

An amount of 50 g (0.23 mol) of polycarboxylic acid (β.1) were dissolved in 700 ml of acetone which was not dried before the reaction and therefore comprised water and placed in a 4-l four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further five hours under reflux at 55° C. Thereafter, 225 g of diol (b.5) (0.15 mol) were added. The temperature was increased to 55° C. and stirred at this temperature for five hours. Then acetone was distilled off in the course of 6 hours at atmospheric pressure. Thereafter the mixture was heated to 60° C. and the pressure reduced to 200 mbar. This produced reaction product RP.10 according to the invention as a solid yellow mass, which was subsequently dissolved in 400 ml 1,3-dioxolane.

OH number: 9 mg KOH/g
Acid value: 20 mg KOH/g
I.11 Synthesis of reaction product RP.11

An amount of 50 g (0.23 mol) of polycarboxylic acid (β.1) were dissolved in 700 ml of acetone which was not dried before the reaction and therefore comprised water and placed in a 4-l four-neck flask having a dropping funnel, reflux cooler, internal thermometer and Teflon agitator. Then, 58 g (0.23 mol) of isocyanate (α.3) were added dropwise at 20° C. The mixture was heated to 55° C. with stirring. The mixture was stirred for a further five hours under reflux at 55° C. Thereafter, 150 g of diol (b.4) (0.15 mol) were added. The temperature was increased to 55° C. and stirred at this temperature for five hours. Then acetone was distilled off in the course of 6 hours at atmospheric pressure. Thereafter the mixture was heated to 60° C. and the pressure reduced to 200 mbar. This produced reaction product RP.11 according to the invention as a solid yellow mass, which was subsequently dissolved in 350 ml 1,3-dioxolane.

OH number: 12 mg KOH/g
Acid value: 40 mg KOH/g

### I.12 Synthesis of Reaction Product RP.12

An amount of 50 g (0.23 mol) of polycarboxylic acid (β.1) were dissolved in 700 ml of acetone which was not dried before the reaction and therefore comprised water and placed in a 4-l four-neck flask having a dropping funnel, reflux cooler, internal thermometer and Teflon agitator. Then, 115 g (0.46 mol) of isocyanate (α.3) were added dropwise at 20° C. The mixture was heated to 55° C. with stirring. The mixture was stirred for a further six hours under reflux at 55° C. Thereafter, 460 g of diol (b.1) (0.46 mol) were added. The temperature was increased to 55° C. and stirred at this temperature for seven hours. Then acetone was distilled off in the course of two hours at atmospheric pressure. Thereafter the mixture was heated to 60° C. and the pressure reduced to 300 mbar. This produced reaction product RP.12 according to the invention as a solid yellow mass, which was dissolved in 625 ml 1,3-dioxolane.

Mₙ=10030 g/mol, M_{w}=22090 g/mol

### M_{w}/Mₙ=2.2

OH number: 6 mg KOH/g
Acid value: 26 mg KOH/g

### I.13 Synthesis of Reaction Product RP.13

An amount of 100 g (0.46 mol) of polycarboxylic acid (β.1) were dissolved in 1400 ml of acetone, which was not dried before the reaction and therefore comprised water, and placed in a 4-l four-neck flask having a dropping funnel, reflux cooler, internal thermometer and Teflon agitator. Then, 173 g (0.69 mol) of isocyanate (α.3) were added at 20° C. The mixture was heated to 55° C. with stirring. The mixture was stirred for a further six hours under reflux at 55° C. Thereafter, 600 g of diol (b.1) (0.60 mol) were added. The temperature was increased to 55° C. and stirred at this temperature for three hours. Then acetone was distilled off in the course of two hours at atmospheric pressure. Thereafter the mixture was heated to 125° C. and the pressure reduced to 300 mbar. This produced reaction product RP.13 according to the invention as a solid yellow mass, which was dissolved in 1000 ml 1,3-dioxolane.

Mₙ=8360 g/mol, M_{w}=21000 g/mol

### M_{w}/Mₙ=2.5

OH number: 22 mg KOH/g
Acid value: 88 mg KOH/g

### II. Manufacture of Inventive Separators (D.6) to (D.13)

### General Procedure:

A solution of 20 g of RP.6 in 1,3-dioxolane was provided. The solids content was adjusted by addition of 1,3-dioxolane, if necessary, and then warmed to 80° C. Polyisocyanate (α.1) was added, and the solution so obtained was applied at 80° C. with a doctor blade method to a glass plate. The solvent-containing film so obtained had a thickness of 15 μm. The 1,3-dioxoloane was allowed to evaporate for 10 minutes at 80° C. The film was then—together with the glass plate—placed into a water bath having room temperature for 1 hour. Then, a film was removed manually and dried over a period of 24 hours under vacuum at 80° C. Inventive separator (D.6) was so obtained.

Inventive separators (D.7) to (D.13) could be made accordingly. Details are summarized in table 1.

TABLE 1
Manufacture of inventive separators

| | | Solid content | Amount | Amount |
|---|---|---|---|---|
| Reaction | | reaction product | reaction product | (α. 1) |
| product | Separator | [wt %] | [g] | [g] |
| RP. 6 | D. 6 | 30.0 | 20.0 | 2.58 |
| RP. 7 | D. 7 | 18.0 | 33.5 | 2.95 |
| RP. 8 | D. 8 | 19.3 | 31.3 | 2.99 |
| RP. 9 | D. 9 | 30.0 | 20.0 | 2.30 |
| RP. 11 | D. 11 | 15.6 | 38.5 | 0.13 |
| RP. 13 | D. 13 | 30.0 | 20 | 1.57 |

The specific electric conductivities of inventive separators (D.6) to (D.13) were determined in 1 M solutions of LiPF₆ in a 1:1 (by weight) mixture of ethylene carbonate/ethylmethyl carbonate (commercially available as LP 50 SelectiLyte™). The results are summarized in table 2.

TABLE 2
Specific electric conductivities of inventive separators

| | | Specific electric |
|---|---|---|
| | Thickness | conductivity |
| Separator | [μm] | [mS/cm] |
| (D. 6) | 15 | 0.04 |
| (D. 7) | 26 | 0.08 |
| (D. 8) | 62 | 0.63 |
| (D. 9) | 107 | 1.11 |
| (D. 11) | 85 | 0.84 |
| (D. 13) | 47 | 0.13 |

### III. Test of Inventive Separator (D.13) in an Electrochemical Cell for a Lithium Ion Battery

An inventive electrochemical cell (EC.13) according to FIG. 1 was assembled.

The labels in FIG. 1 mean:
1, 1′ Dies
2, 2′ Nuts
3, 3′ Sealing ring—two in each case, the second sealing ring in each case, which is somewhat smaller, not being shown here
4 Coil spring
5 Nickel output conductor
6 Housing

Anode: graphite on copper foil as current collector with a thickness of 36 to 38 μm.

Cathode: LiNi_{0.8}Co_{0.15}Al_{0.05}O₂, on aluminium foil as current collector.

Electrolyte (C.1): 1 M solution of LiPF₆ in a 1:1 (by weight) mixture of ethylene carbonate/dimethyl carbonate

As cathode (B.1), a nickel manganese spinel electrode was used which had been manufactured as follows.

### 85% LiMn_{1.5}Ni_{0.5}O₄

6% PVdF, commercially available as Kynar Flex® 2801 of Arkema Group,
6% carbon black, BET surface 62 m²/g, commercially available as “Super P Li” by Timcal,
3% graphite, commercially available as KS6 by Timcal,
were mixed in a container with a lid. Under stirring, an amount of NMP was added until a viscous lump-free paste was obtained. Stirring was performed over a time of 16 hours.

The paste so obtained was applied to an aluminium foil (thickness of the aluminium foil: 20 μm) with a knife blade. Then, the aluminium foil so coated was dried in a drying cabinet at 120° C. under vacuum. The thickness of the dried coating was 30 μm. Then round segments were punched out, diameter: 12 mm.

Inventive electrochemical cell (EC.13) was charged with a constant current to a voltage of 4.2 V followed by a final charging with constant voltage at 4.2 V. Then, inventive electrochemical cell (EC.13) was discharged at constant current to a voltage of 3 V. Fifteen such cycles with C/24 were determined. The capacity was determined to be 50 to 70 mA·h.

1. A separator, comprising:
a product of
(a) at least one polyimide, which is a condensation product of
(α) at least one polyisocyanate comprising on average at least two isocyanate groups per molecule and
(β) at least one polycarboxylic acid comprising at least 3 COOH groups per molecule or an anhydride or ester thereof, and
(b) at least one diol or triol,
which is subsequently optionally reacted with
(c) at least one polyisocyanate comprising on average at least two isocyanate groups per molecule.

2. The separator according to claim 1, further comprising one or more inorganic particles.

3. The separator according to claim 1, wherein a polycarboxylic acid comprising at least 4 COOH groups per molecule, or a respective anhydride or ester, is selected as the at least one polycarboxylic acid (β).

4. The separator according to claim 1 wherein the at least one polyisocyanate (α) is selected from the group consisting of an oligomeric hexamethylene diisocyanate, an oligomeric tetramethylene diisocyanate, an oligomeric isophorone diisocyanate, an oligomeric diphenylmethane diisocyanate, an oligomeric tolylene diisocyanate, and any mixture thereof.

5. The separator according to claim 1, which has a thickness of from 1 to 150 μm.

6. An electrochemical cell, comprising
an anode as component (A),
a cathode as component (B),
a non-aqueous electrolyte as component (C), and
at least one separator according to claim 1.

7. The electrochemical cell according to claim 6, which is a lithium-ion comprising cell.

8. The electrochemical cell according to claim 6, wherein the anode (A) is a graphite anode or a lithium titanate anode.

9. The electrochemical cell according to claim 6, wherein the cathode (B) comprises at least one material selected from the group consisting of a lithium comprising transition metal spinel and a lithium transition metal oxide with a layered crystal structure.

10. The electrochemical cell according to claim 6, wherein the at least one polyimide (a) has a polydispersity M_{w}/Mₙ of at least 1.4.

11. The electrochemical cell according to claim 9, wherein the lithium transition metal oxide with a layered crystal structure is represented by formula Li₍₁₊ₓ₎[NiₑCo_{f}Mn_{g}M²ₕ]₍₁₋ₓ₎O₂, where:
M² is selected from the group consisting of Al, Mg, V, Fe, Cr, Zn, Cu, Ti and Mo,
x is a number of from zero to 0.2,
e is a number of from 0.2 to 0.6,
f is a number of from 0.1 to 0.5,
g is a number of from 0.2 to 0.6,
h is a number of from zero to 0.2, and
e+f+g+h=1.

12. The electrochemical cell according to claim 6, wherein the cathode (B) comprises a material based on electrically conductive carbon.

13. A battery, comprising: at least one electrochemical cell according to claim 6.

14. A device, comprising: the electrochemical cells according to claim 6,
wherein the device is an operating car, a computer, a personal digital assistant, a mobile telephone, a watch, a camcorder, a digital camera, a thermometer, a calculator, a laptop BIOS, a communication equipment or a remote car lock.

15. A device, comprising: the battery according to claim 13,
wherein the device is an operating car, a computer, a personal digital assistant, a mobile telephone, a watch, a camcorder, a digital camera, a thermometer, a calculator, a laptop BIOS, a communication equipment or a remote car lock.
